(19) United States
(12) Patent Application Publication
(10) Pub. No.: US 2013/0021242 A1
(43) Pub. Date: Jan. 24, 2013

(54) ADVANCED HANDWRITING SYSTEM WITH MULTI-TOUCH FEATURES

(71) Applicants: Qi-Zhen He, Shanghai (CN); Feng-Jun Guo, Shanghai (CN); Wei Lin, Lake Zurich, IL (US); Duan-Duan Yang, Shanghai (CN)

(72) Inventors: Qi-Zhen He, Shanghai (CN); Feng-Jun Guo, Shanghai (CN); Wei Lin, Lake Zurich, IL (US); Duan-Duan Yang, Shanghai (CN)

(73) Assignee: MOTOROLA SOLUTIONS, INC., Schaumburg, IL (US)

(21) Appl. No.: 13/184,802

(22) Filed: Jul. 18, 2011

(51) Int. Cl. G06F 3/041; G06F 3/033

(52) U.S. Cl. 345/157; 345/173

(57) ABSTRACT

An electronic device includes a handwriting recognition (HWR) application. The electronic device includes a processor configured to execute the HWR application and a memory storing the HWR application. The electronic device includes a display configured to receive a finger gesture. The HWR application determines a setting data as a function of (a) a number of fingers used in a first contact of the finger gesture and (b) a first position of the first contact on the display relative to a second position of the first contact on the display within a predetermined time period. The HWR application further determines an input data to be entered as a function of the setting data and at least one of (i) a movement of the finger gesture and (ii) a second contact of the finger gesture on the display.

### BACKGROUND

An electronic device may be configured with a variety of input devices. For example, the electronic device may include a conventional keypad such as a keyboard. In another example, the electronic device may include a touch input receiving device such as a touch screen display or a touch pad that receives inputs for selected functionalities. In yet another example, the electronic device may include a specialized touch screen in which a stylus is required to receive inputs.

When the electronic device includes a touch input receiving device (e.g., touch screen display), it may be configured to further receive inputs such as those that are handwriting related (e.g., letters, numbers, etc.) when a keypad is not shown thereon. However, the handwriting recognition systems available on conventional electronic devices are inconvenient with regards to the unnatural manner in which inputs must be entered. For example, a certain letter to be entered properly may be configured with a different design than the letter itself which causes users to have to spend time to learn the designs. In another example, touch input receiving device may only be configured in a certain area of the display in which the user must learn. Furthermore, conventional touch input receiving devices require an initial input to indicate a particular setting for the inputs that will be entered.

### SUMMARY OF THE INVENTION

The present invention relates an electronic device with a handwriting recognition (HWR) application. The electronic device includes a processor configured to execute the HWR application and a memory storing the HWR application. The electronic device includes a display configured to receive a finger gesture. The HWR application determines a setting data as a function of (a) a number of fingers used in a first contact of the finger gesture and (b) a first position of the first contact on the display relative to a second position of the first contact on the display within a predetermined time period. The HWR application further determines an input data to be entered as a function of the setting data and at least one of (i) a movement of the finger gesture and (ii) a second contact of the finger gesture on the display.

### DESCRIPTION OF THE DRAWINGS

FIG. 1 shows an electronic device according to an exemplary embodiment of the present invention.

FIG. 2 shows a method for determining a touch input according to an exemplary embodiment of the present invention.

### DETAILED DESCRIPTION

The exemplary embodiments may be further understood with reference to the following description and the appended drawings, wherein like elements are referred to with the same reference numerals. The exemplary embodiments describe a handwriting recognition (HWR) system for a display including an input device. Specifically, the HWR allows a user to freely enter finger gestures in which a setting and an input to be entered are determined by the HWR. The HWR, the finger gesture, the setting, the input to be entered, and a related method will be discussed in further detail below.

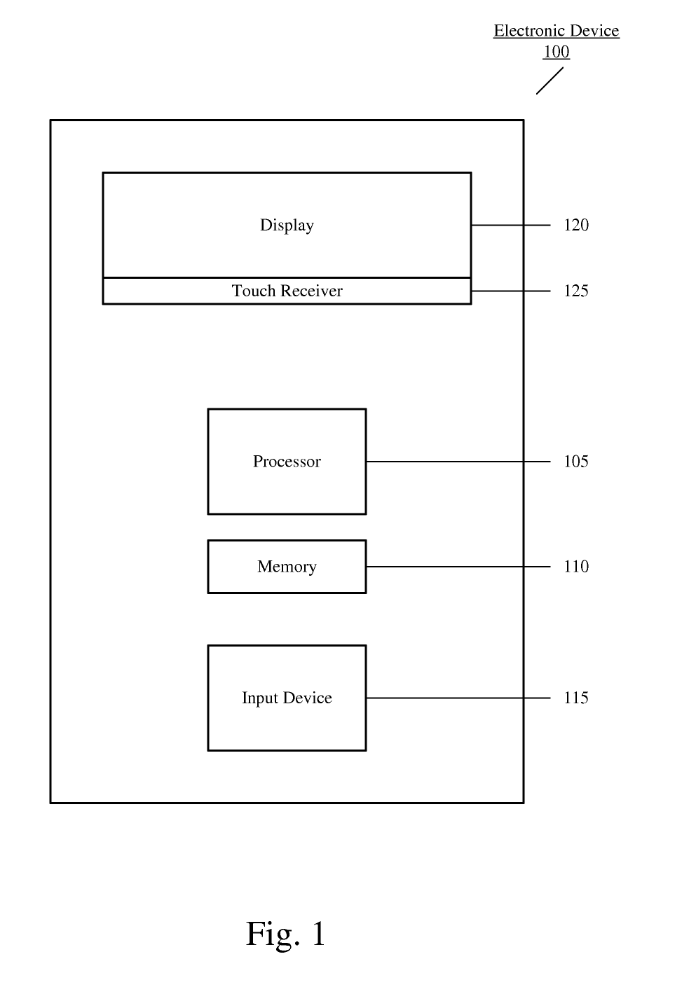

FIG. 1 shows an electronic device 100 according to an exemplary embodiment of the present invention. The device 100 may be any electronic device such as a portable device (e.g., smart-phone, PDA, laptop, etc.) or a stationary device (e.g., desktop, copy machine, network server, etc.). The device 100 may include a processor 105, a memory 110, an input device 115, a display 120, and a touch receiver 125. It should be noted that the device 100 may include a variety of other conventional components such as a transceiver, a power supply, ports to connect to other devices, etc.

The processor 105 may provide conventional functionalities for the device 100. For example, the device 100 may include a plurality of applications that are executed on the processor 105 such as a word processing application or a web browser. The processor 105 may also receive gestures entered via the input device 115 and/or the display 120. The memory 110 may also provide conventional functionalities for the device 100. For example, the memory 110 may store data related to operations performed by the processor 105. As will be described in further detail below, the memory 110 may also store preset gestures to indicate a setting and an input to be entered. Specifically, the device 100 may include a handwriting recognition (HWR) system which may be a program executed on the processor 105 and stored in the memory 110.

The input device 115 may be any conventional input component such as a keypad, a mouse, etc. It should be noted that although the device 100 includes a display configured to receive finger gestures thereon, a conventional input device 115 may also be provided. The display 120 may be any conventional display that is configured to display data to the user. Furthermore, the display 120 may be configured to receive finger gestures to enable a user to enter inputs via a touch interface. The touch receiver 125 may be configured to receive the touch inputs from the display 120. It should be noted that the finger gestures may be provided via a variety of manners such as a tactile contact, a heat contact, a combination thereof, etc.

According to the exemplary embodiments of the present invention, the display 120 may receive a variety of different finger gestures that indicate both a setting and an input to be entered. Specifically, the finger gestures may include a variety of different characteristics to determine the setting such as an initial or first contact of the finger gesture including a number of fingers used, a change in position on the display within a predetermined time period, a hold in position on the display within the predetermined position. The finger gestures may include a variety of different characteristics to determine the input to be entered such as a movement of the finger gesture and a subsequent or second contact of the finger gesture on the display. As will be described in further detail below, the finger gestures may relate to entering letters and numbers as well as distinguishing between them, moving a cursor, changing an input mode of a virtual keyboard, changing a size of inputs, and changing a style for inputs.

The display 120 and the touch receiver 125 may be configured to receive the finger gestures for entering letters and/or numbers. The HWR of the exemplary embodiments further distinguishes between letters and numbers without a need for having predetermined locations on the display 120 reserved for the entering of letters/numbers as well as not requiring an initial input such as requiring a mode button to be pushed (e.g., button that changes between number inputs and letter inputs). Those skilled in the art will understand that entering of letters and numbers include several characters that have a substantially similar shape. For example, the number “2” and the letter “z” may be interchangeable on conventional HWR systems. Further examples include the number “1” and the lower case letter “L”; the number “0” and the letter “O”. The exemplary embodiments of the present invention provide a system that allows for a continuous input of characters without a need to change a setting manually prior to a setting change (e.g., from alphabetic to numeric).

The HWR of the exemplary embodiments provide a finger gesture to be distinguished between numeric inputs and alphabetic inputs through the finger gesture itself. According to the exemplary embodiments of the present invention, when a finger gesture is made with two fingers, the HWR receives and interprets the finger gesture to be, for example, a numeric symbol. When a finger gesture is made with one finger, the HWR receives and interprets the finger gesture to be, for example, an alphabetic symbol. Accordingly, any finger gesture used for entering a symbol may indicate a setting (e.g., numeric or alphabetic) while a movement of the finger gesture will indicate the input itself, thereby there is no need to provide the setting beforehand.

It should be noted that the configuration may be interchangeable so that a one finger design relates to numeric symbols while a two finger design relates to alphabetic symbols. It should also be noted that the numeric symbols may also include typographic symbols such as colons, semicolons, commas, periods, dashes, slashes, etc. It should further be noted that the configuration may include further embodiments. For example, a three finger input may relate to other typographic symbols that are not included in the other two input designs.

The display 120 and the touch receiver 125 may be configured to move a cursor on the display. A cursor may represent an indication of a current location within, for example, a body of text. To prevent any confusion that a finger gesture used for the movement of the cursor is taken for entering an input (e.g., a letter), the HWR of the exemplary embodiments provide a finger gesture to indicate the setting that the cursor is to be moved and the location that the cursor is to be moved. Those skilled in the art will understand that conventional HWR systems may interpret a cursor moving action for an entering of a symbol. The conventional HWR systems may also require further preliminary actions to be taken for the cursor to be moved. For example, a full-screen mode is required to be exited.

The HWR of the exemplary embodiments provide a finger gesture to move the cursor without any confusion and require a single finger gesture. According to the exemplary embodiments of the present invention, a first finger may be pressed and held on the display 120 (i.e., no change in position over a specified period of time) while a second finger is tapped at a location (i.e., a further contact on the display). The HWR interprets this finger gesture to indicate the setting for cursor movement and also moves the cursor to the location that is tapped by the second finger. As this touch input is unlike any of the prior described inputs, the HWR is capable of undoubtedly understanding the intentions of the user providing this finger gesture.

The display 120 and the touch receiver 125 may be configured to change the input mode of a virtual keyboard without requiring a predetermined button. The HWR of the exemplary embodiments may allow for entering of symbols for multiple languages (e.g., English, Pinyin, etc.). Those skilled in the art will understand that conventional HWR systems may include this functionality. However, some conventional HWR systems require multiple inputs spanning different menus to ultimately change the language setting. Other conventional HWR systems always require a button that is disposed in a set location for indicating the change in input entry.

The HWR of the exemplary embodiments provide a finger gesture anywhere that inputs are received on the display 120 that changes the setting of the language. The user of the device 100 may configure at least two languages to be available for data entry. According to the exemplary embodiments of the present invention, when a user uses two fingers (i.e., a first contact of the finger gesture) and double clicks (i.e., a second contact of the finger gesture on the display), the language setting may be changed from a first language to a second language. Accordingly, when the user uses two fingers and double clicks, the language setting may be reverted from the second language to the first language. Thus, the HWR provides a seamless way of inputting mixed lines between two languages. As this finger gesture is unlike any of the prior described inputs, the HWR is capable of undoubtedly understanding the intentions of the user providing this finger gesture.

The display 120 and the touch receiver 125 may be configured to change the size of inputs. Specifically, when a symbol has already been entered, a further finger gesture may alter the size thereof. Those skilled in the art will understand that such a functionality may be provided in conventional HWR systems but include substantially similar issues as the change in language. Specifically, the user may be required to provide multiple initial inputs spanning different menus to ultimately change the size of the input.

The HWR of the exemplary embodiments provide a finger gesture without providing a separate input to access settings to alter a size of the entered symbol. According to the exemplary embodiments of the present invention, when a user uses two fingers (i.e., a first contact of the finger gesture) and changes a distance between the fingers while contacting the display 120 (i.e., a movement of the finger gesture), the HWR recognizes this finger gesture to indicate an increase or a decrease for the size of the entered symbol. Specifically, a movement of the fingers toward each other is interpreted by the HWR to decrease the size while a movement of the fingers away from each other is interpreted by the HWR to increase the size. It should be noted that the change to the size of the inputs may be for only an entered symbol or may be a global change that is used until the size is changed at a later time. As this finger gesture is unlike any of the prior described inputs, the HWR is capable of undoubtedly understanding the intentions of the user providing this finger gesture.

The display 120 and the touch receiver 125 may be configured to change the style for inputs such as a color scheme. Substantially similar to the previous issues associated with conventional HWR systems, to change a style for the inputs, the user may be required to provide multiple initial inputs spanning different menus to ultimately change the style of the input.

The HWR of the exemplary embodiments provide a finger gesture without providing a separate input to access settings to alter a style of the entered symbol. According to the exemplary embodiments of the present invention, when a user uses two fingers and holds the fingers on the display 120 (i.e., a first contact of the finger gesture with no change in position over a specified period of time), the HWR recognizes this motion and displays a color panel. Subsequently, the user is allowed to select a color with one of the fingers while the other is held (i.e., a second contact of the finger gesture on the display). It should be noted that the change to the style of the inputs may be for only an entered symbol or may be a global change that is used until the style is changed at a later time. This configuration for altering a style differs, for example, from the cursor movement as the two fingers are first held on the display 120 prior to a further tap on the display 120. Accordingly, this finger gesture is unlike any of the prior described inputs and the HWR is capable of undoubtedly understanding the intentions of the user providing this finger gesture.

It should be noted that the above described finger gestures for the HWR of the present invention are only exemplary. The HWR of the present invention may incorporate further finger gestures that utilize a design that is readily distinguishable from the above described designs to allow the HWR to properly interpret the finger gesture, thereby provide a correct setting and an input to be entered.

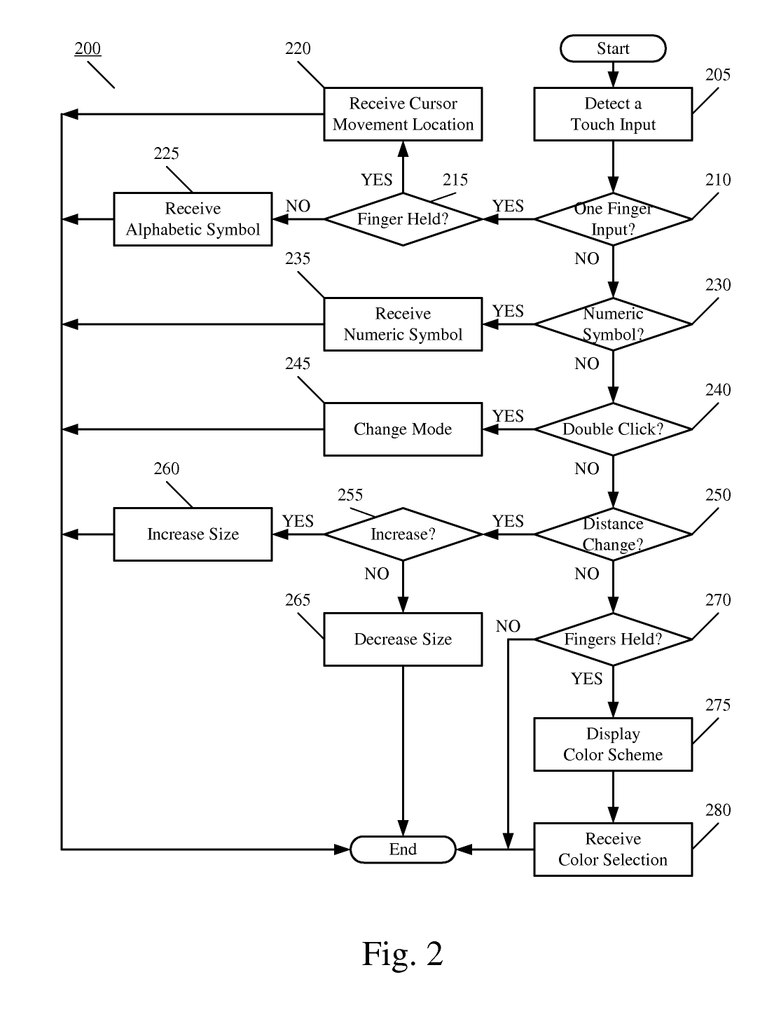

FIG. 2 shows a method 200 for determining a finger gesture of the HWR according to an exemplary embodiment of the present invention. The method 200 will be described with reference to the device 100 of FIG. 1 and its components. The method 200 incorporates the possible finger gestures as described above. However, it should be noted that the finger gestures described above and herein are only exemplary and the HWR of the present invention may include further finger gestures.

In step 205, a finger gesture is received. As described above, the device 100 may include the display 120 and the touch receiver 125 that constitute a touch screen display to enable a user to provide a finger gesture directly on a surface of the display 120. Upon receiving the finger gesture, the HWR of the device 100 may interpret it to determine a proper setting and a corresponding input.

In step 210, a determination is made whether the touch input was made with one finger. That is, an initial contact of the finger gesture is used as an initial determinant for the setting. If the finger gesture was made with one finger, the method 200 continues to step 215 where a further determination is made whether the one finger was held on the display 120. That is, a change in position is used as a further determinant for the setting. The touch receiver 125 may send a signal to the processor 105 that the one finger was held on the display 120. That is, there is no change in position over a specified period of time. Subsequently, the method 200 continues to step 220 and the HWR determines the setting that the user wishes to move the cursor. Thus, in step 220, while the one finger is held, a second finger contacts the display 120 to indicate a position for the cursor location. That is, a second contact of the finger gesture is received on the display. Returning to step 215, if the one finger was not held (i.e., there is a change in position within the specified period of time), the method 200 continues to step 225 and the HWR determines the setting that the user wishes to enter an alphabetic symbol. Specifically, the touch receiver 125 may send a signal to the processor 105 that the one finger input includes no substantial delay and also includes a substantially immediate movement while the one finger remains on the display 120. Thus, in step 225, the design and movement of the finger gesture with the one finger is deciphered and the HWR determines which letter to enter.

Returning to step 210, if the determination was made that the finger gesture was not a one finger input, it may be assumed for the exemplary embodiments discussed above that the finger gesture was made with two fingers. However, it should be noted that the assumption is only exemplary and if the HWR according to the exemplary embodiments of the present invention include other finger gestures using three or more fingers, the method 200 may include further steps to incorporate these finger gestures.

Once the determination is made that the finger gesture is a two finger input, the method 200 continues from step 210 to step 230. In step 230, a determination is made whether the two finger input is for a numeric symbol entry. Specifically, the touch receiver 125 may send a signal to the processor 105 that the two finger input includes no substantial delay and also includes a substantially immediate movement while the two fingers remain on the display 120. The HWR of the present invention may determine the setting that the two finger input is for a numeric symbol entry. Thus, the method 200 continues to step 235 where the numeric symbol entry is received.

Returning to step 230, if the two finger input is not for a numeric symbol entry, the method 200 continues to step 240. In step 240, a determination is made whether the two finger input was performed with a double click. Specifically, the touch receiver 125 may send a signal to the processor 105 that two fingers simultaneously tapped the display 120 a first time and a second time within a predetermined time period. When this occurs, the HWR of the present invention may determine the setting that the two finger input is to change a mode such as language. Thus, the method 200 continues to step 245 where the mode is changed.

Returning to step 240, if the two finger input is not a double click, the method 200 continues to step 250. In step 250, a determination is made whether the two finger input included a distance change between the two fingers. Specifically, the touch receiver 125 may send a signal to the processor 105 that the two fingers tapped the display 120 and at least one of the fingers (while remaining on the display 120) moved toward or away from the other finger. When this occurs, the HWR of the present invention may determine the setting that the two finger input is to change a size of the entries. Thus, the method 200 continues to step 255 to determine whether the distance change increased or decreased. If the distance increased between the two fingers, the method 200 continues to step 260 where the size is increased or if the distance decreased between the two fingers, the method 200 continues to step 265 where the size is decreased.

Returning to step 250, if the two finger input does not include a distance change, the method 200 continues to step 270. In step 270, a determination is made whether the two finger input includes a hold by the two fingers on the display 120. Specifically, the touch receiver 125 may send a signal to the processor 105 that the two fingers contacted the display 120 and remained in contact with the display 120. When this occurs, the HWR of the present invention may determine the setting that the user wishes to change a style of entry such as color. Thus, the method 200 continues to step 275 where the color scheme is shown on the display 120. According to the exemplary embodiments, the color scheme may be an extending menu that starts from a first contact point from one of the fingers to allow one finger to remain in contact with the display 120 and allow the other finger to select the color (step 280).

The exemplary embodiments of the present invention provide a handwriting recognition system that incorporates multiple configurations that are substantially different from each other that the recognition may indicate both a setting and an input. For example, the configurations and/or designs may include the use of a single finger versus two fingers, a holding of the finger(s) on the display for a predetermined amount of time, a movement of the finger(s) on the display within the predetermined amount of time, a double click from the finger(s), a change in distance between fingers, etc. Through incorporation of the different possible finger gestures, the handwriting recognition system of the present invention is configured to remove any necessity to provide preliminary inputs to prepare the system before actually inputting the entry. That is, the handwriting recognition system of the present invention allows for a single finger gesture to indicate at least the setting and the input to be entered. Accordingly, settings such as entering an alphabetic or numeric symbol, moving a cursor location, changing a language mode, increasing an entry size, changing an entry style scheme, etc. may be provided to the user of the device in a manner that eliminates additional steps necessary in conventional handwriting recognition systems.

Those skilled in the art will understand that the above described exemplary embodiments may be implemented in any number of manners, including, as a separate software module, as a combination of hardware and software, etc. For example, the HWR may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An electronic device, comprising:
a processor configured to execute a handwriting recognition (HWR) application;
a memory storing the HWR application; and
a display configured to receive a finger gesture, the HWR application determining a setting data as a function of (a) a number of fingers used in a first contact of the finger gesture and (b) a first position of the first contact on the display relative to a second position of the first contact on the display within a predetermined time period, the HWR application further determining an input data to be entered as a function of the setting data and at least one of (i) a movement of the finger gesture and (ii) a second contact of the finger gesture on the display.

2. The electronic device of claim 1, wherein the number of fingers used in the first contact is one of a one finger gesture and a two finger gesture.

3. The electronic device of claim 2, wherein the one finger gesture includes a change between the first and second positions within the predetermined time period to indicate the setting data to be an entry of an alphabetic symbol and the movement is an alphabetic design to indicate that the input data is a letter.

4. The electronic device of claim 2, wherein the one finger gesture includes no change between the first and second positions within the predetermined time period to indicate the setting data to be a movement of a cursor location and the second contact indicates the cursor location.

5. The electronic device of claim 2, wherein the two finger gesture includes a change between the first and second positions within the predetermined time period to indicate the setting data to be an entry of a numeric symbol and the movement is a numeric design to indicate that the input data is a number.

6. The electronic device of claim 2, wherein the two finger gesture includes a change between the first and second positions within the predetermined time period via a double click to indicate the setting data to be a change in a mode and the input data is determined as the change to the mode.

7. The electronic device of claim 6, wherein the mode is a language.

8. The electronic device of claim 2, wherein the two finger gesture includes a distance change between the two fingers from the first position to the second position within the predetermined time period indicates the setting data to be a change in size and the distance change indicates the input data to be a change in size.

9. The electronic device of claim 2, wherein the two finger gesture includes no change between the first and second positions within the predetermined time period to indicate the setting data to be a change in a style and the second contact indicates the input data to be a change in the style.

10. The electronic device of claim 9, wherein the style is a color scheme.

11. A method, comprising:
receiving a finger gesture on a display;
determining a setting data as a function of (a) a number of fingers used in a first contact of the finger gesture and (b) a first position of the first contact on the display relative to a second position of the first contact on the display within a predetermined time period; and
determining an input data to be entered as a function of the setting data and at least one of (i) a movement of the finger gesture and (ii) a second contact of the finger gesture on the display.

12. The method of claim 11, wherein the number of fingers used in the first contact is one of a one finger gesture and a two finger gesture.

13. The method of claim 11, wherein the one finger gesture includes a change between the first and second positions within the predetermined time period to indicate the setting data to be an entry of an alphabetic symbol and the movement is an alphabetic design to indicate that the input data is a letter.

14. The method of claim 11, wherein the one finger gesture includes no change between the first and second positions within the predetermined time period to indicate the setting data to be a movement of a cursor location and the second contact indicates the cursor location.

15. The method of claim 11, wherein the two finger gesture includes a change between the first and second positions within the predetermined time period to indicate the setting data to be an entry of a numeric symbol and the movement is a numeric design to indicate that the input data is a number.

16. The method of claim 11, wherein the two finger gesture includes a change between the first and second positions within the predetermined time period via a double click to indicate the setting data to be a change in a mode and the input data is determined as the change to the mode, the mode being a language.

17. The method of claim 11, wherein the two finger gesture includes a distance change between the two fingers from the first position to the second position within the predetermined time period indicates the setting data to be a change in size and the distance change indicates the input data to be a change in size.

18. The method of claim 11, wherein the two finger gesture includes no change between the first and second positions within the predetermined time period to indicate the setting data to be a change in a style and the second contact indicates the input data to be a change in the style, the style being a color scheme.

19. A computer readable storage medium including a set of instructions executable by a processor, the set of instructions operable to:
receive a finger gesture on a display;
determine a setting data as a function of (a) a number of fingers used in a first contact of the finger gesture and (b) a first position of the first contact on the display relative to a second position of the first contact on the display within a predetermined time period; and
determine an input data to be entered as a function of the setting data and at least one of (i) a movement of the finger gesture and (ii) a second contact of the finger gesture on the display.

20. The computer readable storage medium of claim 19, wherein the number of fingers used in the first contact is one of a one finger gesture and a two finger gesture.
